(19) United States
(12) Patent Application Publication
(10) Pub. No.: US 2011/0059300 A1
(43) Pub. Date: Mar. 10, 2011

(54) Molded Product Assembly

(75) Inventors: Jae-Kyung KIM, Uiwang-si (KR); Jeong-Mi SEO, Uiwang-si (KR); Hyoung-Joo CHUNG, Uiwang-si (KR)

(73) Assignee: CHEIL INDUSTRIES INC., Gumi-si (KR)

(21) Appl. No.: 12/868,019

(22) Filed: Aug. 25, 2010

(30) Foreign Application Priority Data
Sep. 9, 2009 (KR) 10-2009-0085010

(51) Int. Cl. B32B 7/02; B32B 33/00

(52) U.S. Cl. 428/195.1; 428/212

(57) ABSTRACT

The present invention provides a molded product assembly. The molded product assembly includes a first molded product having a transparency ranging from about 75 to about 99.9% and a second molded product having a transparency ranging from about 0.1 to about 50% and can have a metal texture.

### CROSS REFERENCE TO RELATED APPLICATIONS

This application claims priority to and the benefit of Korean Patent Application No. 10-2009-0085010 filed in the Korean Intellectual Property Office on Sep. 9, 2009, the entire disclosure of which is incorporated herein by reference.

### FIELD OF THE INVENTION

The present invention relates to a molded product assembly that can have a metal-like texture.

### BACKGROUND OF THE INVENTION

Recently, there has been increased interest in the use of plastic resins in exterior parts of various products, such as electronic parts, auto parts, and the like. In addition, plastic parts having various colors and high quality texture are also becoming increasingly popular.

However, the use of plastic parts in various applications can be limited by the ability to impart a metal-like texture to the same. Typically, a metal-like texture can be imparted to plastic products by adding a material having a metal texture, for example, a metal, aluminum flakes, sparkles, pearls, and the like, to a plastic resin.

### SUMMARY OF THE INVENTION

An exemplary embodiment of the present invention provides a molded product assembly having a metal texture. The metal texture can be imparted to the molded product assembly by combining properties such as color, gloss, transparency, corrosion pattern, and the like of a plastic resin without adding a material having a metal texture to a plastic resin.

Another embodiment of the invention provides a molded product assembly having a metal texture by assembling a first molded product having a transparency ranging from about 75 to about 99.9% and a second molded product having a transparency ranging from about 0.1 to about 50%.

The first molded product may have a gloss of about 70 or more at about 60°, and the second molded product may have a gloss ranging from about 0.1 to about 40 at about 60°.

The second molded product can have a corrosion pattern ranging from about 0.001 to about 100 μm deep.

The first and second molded products can have colors in a complementary color relationship or an opposite color relationship to each other.

The first molded product can be prepared from a first resin composition including a first resin having a transparency ranging from about 80 to about 99.9% and a first colorant (i.e., a first dye and/or pigment), and the second molded product can be prepared from a second resin composition including a second resin having transparency ranging from about 0 to about 99.9% and a second colorant (i.e., a second dye and/or pigment).

Each of the first and second resins independently may include a synthetic resin or an environmentally-friendly resin. Exemplary resins useful in the invention include without limitation rubber-modified vinyl-based graft copolymer resins, polyamide resins, polycarbonate resins, polyalkyl(meth)acrylate resins, polyester resins, polyolefin resins, polylactic acid (PLA) resins, polyhydroxy alkanoate (PHA) resins, polybutylene succinate (PBS) resins, starch resins, plant-derived polyamide resins, biosuccinic acid resins, and the like, and combinations thereof.

Each of the first and second colorants can be independently selected from various dyes, pigments, and combinations thereof. Exemplary dyes include without limitation solvent-type dyes, fluorescent whitening agents, fluorescent dyes, mixed dyes, and the like, and combinations thereof. Exemplary pigments includes without limitation organic pigments such as anthraquinone-based pigments, perylene-based pigments, phthalocyanine pigments, azo-based pigments, and the like, and combinations thereof; inorganic pigments such as carbon black, iron oxide black, white pigments, composite metal oxides, ultramarine blue, and the like, and combination thereofs; and combinations of any of the foregoing dyes and/or pigments. The first resin composition may include the first colorant (i.e., first dye and/or pigment) in an amount ranging from about 0.01 to about 1 wt % based on the total weight of the first resin composition, and the second resin composition may include the second colorant (i.e., the second dye and/or pigment) in an amount ranging from about 0.5 to about 50 wt % based on the total weight of the second resin composition.

The molded product assembly may have a gloss ranging from about 70 to about 99 at 60°.

Hereinafter, further aspects of the present invention will be described in detail.

### BRIEF DESCRIPTION OF THE DRAWINGS

FIG. 1 is a photograph showing a molded product assembly prepared by assembling first and second molded products according to one embodiment of the invention.

FIG. 2A is a photograph showing one corrosion pattern for a second molded product according to one embodiment of the invention.

FIG. 2B is a graph showing the length and depth of the corrosion pattern in a region “A” in FIG. 2A.

FIG. 3A is a photograph showing another corrosion pattern of a second molded product according to one embodiment of the invention.

FIG. 3B is a graph showing the length and depth of the corrosion pattern in a region “B” in FIG. 3A.

FIG. 4 is an example of a color ring.

FIG. 5A is a photograph illustrating the excellent metal texture of a molded product assembly of Example 3 (the symbol “⊚” indicating excellent metal texture).

FIG. 5B is a photograph illustrating medium metal texture of a molded product assembly of Example 2 (the symbol “Δ” indicating medium metal texture).

FIG. 5C is a photograph illustrating poor metal texture of a molded product assembly of Comparative Example 1 (the symbol “X” indicating poor metal texture).

### DETAILED DESCRIPTION OF THE INVENTION

The present invention now will be described more fully hereinafter in the following detailed description of the invention and with reference to the accompanying drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “(meth)acrylate” refers to “acrylate” and “methacrylate”. The term “(meth)acrylic acid alkyl ester” refers to “acrylic acid alkyl ester” and “methacrylic acid alkyl ester”, and the term “(meth)acrylic acid ester” refers to “acrylic acid ester” and “methacrylic acid ester”.

As used herein, when a specific definition is not otherwise provided, a “color ring” indicates colors arranged according to the similar color group in a circle shape.

As used herein, when a specific definition is not otherwise provided, the terms “colorant” and/or a “dye and/or pigment” refer to a dye, a pigment, or a combination thereof.

According to one embodiment, the present invention provides technology for accomplishing a metal texture to a plastic article. The skilled artisan will understand the meaning of the term “metal texture.” Non-limiting examples of exemplary metal textures include without limitation brushed, patterned, pearlized, galvanized, rusted, distressed, stamped, shaved, impressed, specific metals (such as the surface appearance of bronze, aluminum, copper, pewter, iron, etc.), sprayed, pearl, and the like.

In the present invention, the metal texture can be achieved by the selection of resin properties, such as transparency or opaqueness, color (by adding a colorant to the resin), gloss, and/or corrosion pattern, and the like. The metal texture accordingly can be achieved with a plastic resin based on the properties of the resin instead of by adding a material to the resin expressing a metal texture thereto.

Hereinafter, a molded product assembly according to one embodiment is illustrated in detail.

The molded product assembly can have metal texture by assembling first and second molded products having different transparency, gloss, and/or corrosion pattern.

The step of assembling the first and second molded products can include, for example, overlapping, stacking, or attaching (for example using an adhesive) the first and second molded products together.

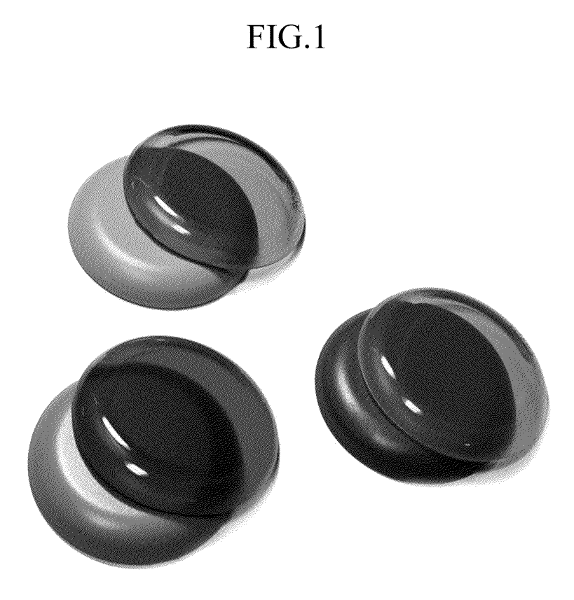

FIG. 1 is a photograph showing a molded product assembly prepared by assembling first and second molded products. Referring to FIG. 1, first and second molded products, that are transparent and opaque materials, respectively, are assembled, and thus the assembly can have a metal texture.

The first molded product is a transparent material having a transparency ranging from about 75 to about 99.9%, for example, from about 75 to about 85%. In some embodiments, the first molded product is a transparent material having a transparency of about 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9%. Further, according to some embodiments of the present invention, the first molded product is a transparent material having a transparency in a range from about any of the foregoing amounts to about any other of the foregoing amounts.

The second molded product is an opaque material having a transparency ranging from about 0.1 to about 50%, for example, from about 0.1 to about 25%. In some embodiments, the second molded product is a transparent material having a transparency of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50%. Further, according to some embodiments of the present invention, the second molded product is a transparent material having a transparency in a range from about any of the foregoing amounts to about any other of the foregoing amounts.

The transparency is evaluated by measuring how much light (on a percentage basis) from a D65 (CIE standard) light source passes through an about 2.5 mm thick molded product using a hazemeter.

A lower transparency %, for example a transparency closer to about 0%, indicates an opaque product, and a higher transparency %, for example a transparency approaching 100%, indicates a transparent product. As used herein, reference to a transparent product refers to product with a transparency of about 75% or greater, such as the first molded product with a transparency from about 75 to about 99.9%, and as another example, from about 75 to about 85%. Also as used herein, reference to an opaque product refers to product with a transparency of about 50% or less, such as the second molded product with a transparency from about 0.1 to about 50%, and as another example, from about 0.1 to about 25%. When the first and second molded products, respectively, have a transparency within the ranges noted herein and are assembled together, the resultant assembly can have an excellent metal texture such as but not limited to brushed, patterned, pearlized, galvanized, rusted, distressed, stamped, shaved, impressed, that of a specific metal (such as the surface appearance of bronze, aluminum, copper, pewter, iron, etc.), sprayed, pearl, and the like.

The first molded product of the transparent material may have gloss of about 70 or more at about 60°, for example, from about 80 to about 99.9 at about 60°. In some embodiments, the first molded product may have a gloss of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9 at about 60°. Further, according to some embodiments of the present invention, the first molded product may have a gloss in a range from about any of the foregoing amounts to about any other of the foregoing amounts.

The second molded product of the opaque material may have gloss having from about 0.1 to about 40 at about 60°, for example, from about 5 to about 20 at about 60°. In some embodiments, the second molded product may have a gloss of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 at about 60°. Further, according to some embodiments of the present invention, the second molded product may have a gloss in a range from about any of the foregoing amounts to about any other of the foregoing amounts.

The gloss is measured using a gloss meter at about 60°. When the first and second molded products, respectively, have a gloss within the ranges noted herein and are assembled together, the resultant assembly can have an excellent high quality metal texture, such as but not limited to brushed, patterned, pearlized, galvanized, rusted, distressed, stamped, shaved, impressed, that of a specific metal (such as the surface appearance of bronze, aluminum, copper, pewter, iron, etc.), sprayed, pearl, and the like.

In an exemplary embodiment, the first molded product of the transparent material has no corrosion pattern on the surface, while the second molded product of the opaque material has a corrosion pattern thereon.

The corrosion pattern on a surface of the second molded product can be obtained by molding the second molded product using any suitable molding equipment having a patterned surface. For example, the corrosion pattern on the second molded product can be obtained by injection molding the second molded product in an injection mold in which a metal surface thereof has a corrosion pattern imparted thereto by a corrosion mechanism known in the art. The corrosion pattern can be obtained by applying a pattern to a metal surface of an injection mold in which a plastic resin is to be molded, and then removing or eliminating metal from the surface of the injection mold through a corrosion mechanism to form the pattern in the surface of the injection mold.

Corrosion mechanisms useful for patterning an injection mold can include chemical corrosion, in which a metal is chemically dissolved, and electrolytic corrosion, in which a metal is electrochemically dissolved. Corrosion patterning of a plastic molded product is generally based on chemical corrosion, and has an advantage of allowing the formation of various patterns, such as leather patterns, wood grain patterns, natural material pattern, fiber and stipple patterns, and the like.

The corrosion pattern formed in the second molded product using the aforementioned corrosion method may be in a range of about 0.001 to about 100 μm deep, for example, in a range of about 5 to about 50 μm deep. In some embodiments, the corrosion pattern formed in the second molded product may have a depth of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 μm. Further, according to some embodiments of the present invention, the corrosion pattern formed in the second molded product may have a depth of in a range from about any of the foregoing amounts to about any other of the foregoing amounts.

When the second molded product has a corrosion pattern within these depth ranges and is assembled with a first molded product, the resultant assembly can have an excellent high quality metal texture such as but not limited to brushed, patterned, pearlized, galvanized, rusted, distressed, stamped, shaved, impressed, that of a specific metal (such as the surface appearance of bronze, aluminum, copper, pewter, iron, etc.), sprayed, pearl, and the like.

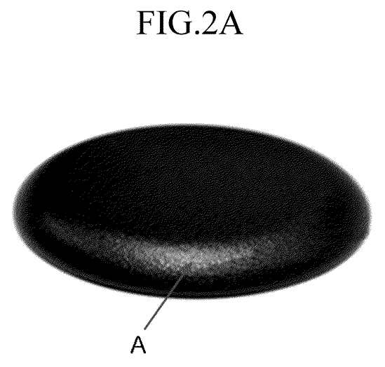

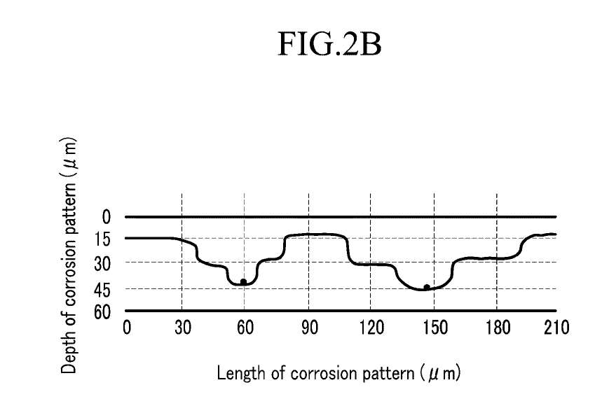

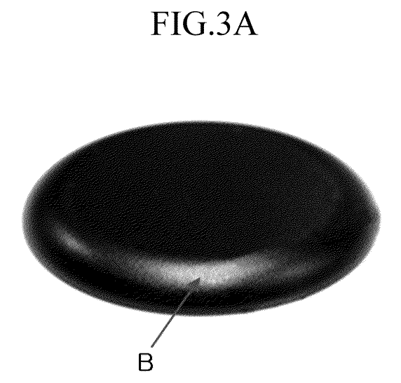

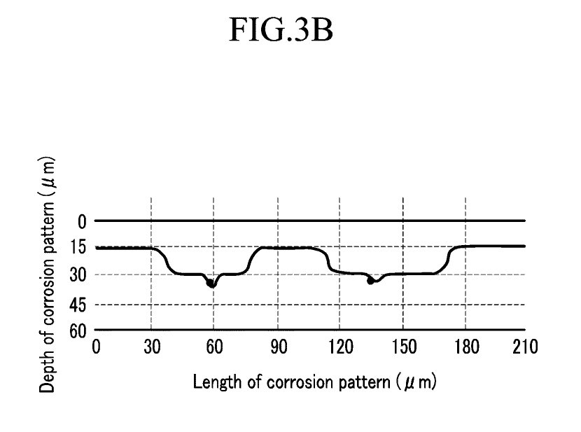

The corrosion pattern of the second molded product can be identified by a photograph such as provided in FIGS. 2A and 2B and FIGS. 3A and 3B. FIG. 2A is a photograph showing a corrosion pattern of the second molded product according to one exemplary embodiment of the invention, and FIG. 2B is a graph showing the length and depth of the corrosion pattern in a region of the second molded product designated at “A” in FIG. 2A. FIG. 3A is a photograph showing another corrosion pattern of the second molded product according to another exemplary embodiment of the invention. FIG. 3B is a graph showing the length and depth of the corrosion pattern in a region of the second molded product designated at “B” in FIG. 3A. Referring to FIGS. 2A to 3B, a horizontal axis in the graph of FIGS. 2B and 3B indicates the length of a corrosion pattern, while a vertical axis indicates the depth of the corrosion pattern. The second molded product shown in FIG. 2A has larger length and depth of a corrosion pattern than the one shown in FIG. 3A. Herein, the length of a corrosion pattern shown in FIGS. 2B and 3B is exemplary and is not limited thereto.

The deeper corrosion pattern the second molded product has, the less gloss it has. Thus the gloss can be regulated by corrosion patterns.

The first and second molded products, respectively, may have various colors. Accordingly, an assembly of the first and second molded products can have various color combinations.

The colors can be displayed in complementary color, opposite color, and similar color relationships.

The term “complementary color relationship” indicates a color combination changing into a color near gray or black when mixed in a particular ratio. In other words, colors in the complementary color relationship are positioned farthest from each other in a color ring.

When a color is combined with its complementary color, it has higher saturation, looks clear, and brightens the other color. This is because the color has the same afterimage as the complementary color.

The term “opposite color relationship” indicates colors positioned far away from each other but closer than the complementary color relationship in a color ring. The term “similar color relationship” indicates colors positioned close to each other but closer than the opposite color relationship.

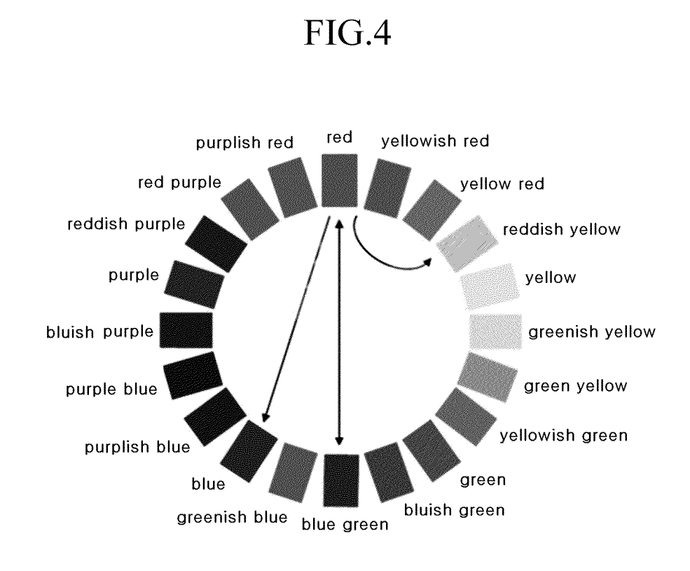

FIG. 4 is a picture showing an example of a color ring. Referring to FIG. 4, examples of the complementary color relationship are red and blue green, yellow and purple blue, and the like, examples of the opposite color relationship are red and blue, yellow and purple, and the like, and examples of the similar color relationship are red and reddish yellow, yellow and yellowish green, and the like.

In particular, the first and second molded products may have colors in a complementary color relationship or an opposite color relationship each other. The color combination in a complementary or opposite relationship can maximize metal texture effects.

The colors realized in an assembly of a molded product can be acquired by combining various different colorants (various different dyes and/or pigments) in the first and second molded products, respectively. For example, the first molded product can include a first colorant and the second molded product can include a second colorant which is complementary to or an opposite color from the first colorant.

The first and second molded products can be prepared from first and second resin compositions, respectively. The first resin composition includes a first resin having a transparency ranging from about 80 to about 99.9% and a first colorant (i.e., a first dye and/or pigment). In some embodiments, the first resin may have a transparency of about 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9%. Further, according to some embodiments of the present invention, the first resin may have a transparency in a range from about any of the foregoing amounts to about any other of the foregoing amounts.

The second resin composition includes a second resin having a transparency ranging from about 0 to about 99.9% and a second colorant (i.e., a second dye and/or pigment). In some embodiments, the second resin may have a transparency of about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9%. Further, according to some embodiments of the present invention, the second resin can have a transparency in a range from about any of the foregoing amounts to about any other of the foregoing amounts.

The second molded product prepared from the second resin composition includes an opaque material. Since the second resin has a transparency ranging from about 0 to about 99.9%, it can be transparent or opaque. The opaqueness of the second molded product, however, can be controlled in various ways, such as controlling the depth of a corrosion pattern and the amount of a colorant (i.e., dye and/or pigment). In this manner, the second molded product can be opaque, even when the second molded product includes a transparent resin. Each of the first and second resins independently include a synthetic resin, an environmentally friendly resin, or a combination thereof. Exemplary synethetic and environmentally friendly resins include without limitation rubber modified vinyl-based graft copolymer resins, polyamide resins, polycarbonate resins, polyalkyl(meth)acrylate resins, polyester resins, polyolefin resins, polylactic acid (PLA) resins, polyhydroxy alkanoate (PHA) resins, polybutylene succinate (PBS) resins, starch resins, plant-derived polyamide resins, biosuccinic acid resins, and the like, and combinations thereof. These resins are known in the art and are commercially available or can be readily prepared by the skilled artisan without undue experimentation. Exemplary resins are discussed in more detail herein, although the present invention is not limited to the exemplified resins.

Exemplary rubber modified vinyl-based graft copolymer resins include without limitation one produced by graft copolymerizing styrene, acrylonitrile, and optionally a methyl(meth)acrylate polymer into a butadiene rubber, an acrylic rubber, a styrene/butadiene rubber, or a combination thereof; or one produced by graft copolymerizing methyl(meth)acrylate into a butadiene rubber, an acrylic rubber, a styrene/butadiene rubber, or a combination thereof.

The polyamide resins may be polymerized using an amino acid, lactam, or diamine, and a dicarboxylic acid including an amide group at the main polymer chain.

The polycarbonate resins can be prepared by reacting a compound selected from the group consisting of diphenols and phosgenes, halogen acid esters, carbonate esters, and combinations thereof.

The polyalkyl(meth)acrylate resins may be prepared by polymerizing an alkyl(meth)acrylate monomer. Exemplary alkyl(meth)acrylate monomers includes a C1 to C10 alkyl group, for example, methyl(meth)acrylate, ethyl(meth)acrylate, butyl(meth)acrylate, glycidyl(meth)acrylate, hydroxyethyl(meth)acrylate, and the like, and combinations thereof.

Exemplary polyester resins may include without limitation a polyethylene terephthalate resin, a polytrimethylene terephthalate resin, a polybutylene terephthalate resin, a polyhexamethylene terephthalate resin, a polycyclohexane dimethylene terephthalate resin, a polyester resin prepared by mixing another monomer with the monomers used to make these resins as known in the art to modify the resin to be non-crystalline, as well as combinations of these resins.

Exemplary polyolefin resins may include without limitation a high density polyethylene (HDPE) resin, a linear low density polyethylene (LLDPE) resin, a polypropylene resin, an ethylene-propylene copolymer resin, an ethylene-vinyl alcohol copolymer resin, and the like, and combinations thereof.

The polylactic acid (PLA) resin may include a repeating unit derived from lactic acid such as L-lactic acid, D-lactic acid, L,D-lactic acid, and a combination thereof or may be a polyester-based resin prepared through an ester reaction using lactic acid acquired by decomposing corn starch as a monomer.

The polyhydroxy alkanoate (PHA) resin is a biodegradable resin, and may include a homopolymer of a single hydroxy alkanoic acid monomer, a copolymer of two or more different hydroxy alkanoic acid monomers, or a blended mixture of a homopolymer and a copolymer. Exemplary hydroxy alkanoic acid monomers may include without limitation 3-hydroxy butyric acid, 3-hydroxy valeric acid, 3-hydroxy hexanoic acid, 3-hydroxy octanoic acid, 3-hydroxy octadecanoic acid, and the like, and combinations thereof. In addition, the polyhydroxy alkanoate resin may include a copolymer including two or more different hydroxy alkanoic acid monomers, for example, poly(3-hydroxy butyric acid-co-3-hydroxy hexanoic acid) or poly(3-hydroxy butyric acid-co-3-hydroxy valeric acid).

The polybutylene succinate (PBS) resin may be prepared through a polycondensation reaction of succinic acid prepared by fermenting a sugary substance such as corn, sugar cane, and the like, and 1,4-butanediol.

Exemplary starch resins may include without limitation a pure starch such as corn starch, rice starch, potato starch, tapioca starch, wheat starch, sweet potato starch, and the like, a modified starch such as an α-starch prepared by physically/chemically treating a pure starch, an acid-treated starch, an oxidized starch, an amphoteric starch, an ester starch, an ether starch, and the like, and combinations thereof.

Exemplary plant-derived polyamide resins may include without limitation polyamide 4, polyamide 6, polyamide 66, polyamide 610, polyamide 1010, polyamide 11, and the like and combinations thereof. Polyamides 4 and 6 can be acquired from a sugaring process of a biomass such as cellulose or starch, polyamide 66 can be acquired from a fermenting process using E-coli bacteria, and polyamides 610, 1010, and 11 can be prepared from castor oil or vegetable oil.

The bio succinic acid resin includes bio succinic acid and derivatives thereof, and can be prepared by fermenting a starch using an enzyme.

Each of the first and second colorants (i.e., each of the first and second dyes and/or pigments) may independently include one or more dyes, one or more pigments, and/or a combination of any of the dyes(s) and/or pigment(s).

Exemplary dyes include without limitation anthraquinone-based dyes, quinoline-based solvent-type dyes, fluorescent whitening agents, fluorescent dyes, mixed dyes, and the like, and combination thereofs.

The pigment may have various colors such as red, green, blue, yellow, violet, and the like. Exemplary pigments include without limitationorganic pigments such as anthraquinone-based pigments, perylene-based pigments, phthalocyanine pigments, azo-based pigments, and the like, inorganic pigments such as carbon black, iron oxide black, white pigment (for example, TiO₂, ZnS, BaSO₄, CaCO₃, and the like), composite metal oxides, ultramarine blue, and the like, and combinations thereof.

The first resin composition may include the first colorant (i.e., the first dye and/or pigment) in an amount of about 0.01 to about 1 wt %, based on the total weight of the first resin composition, and the second resin composition may include the second colorant (i.e., the second dye and/or pigment) in an amount ranging from about 0.5 to about 50 wt %, based on the total weight of the second resin composition.

In some embodiments, the first resin composition may include the first colorant in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, or 1 wt %. Further, according to some embodiments of the present invention, the first resin composition can include the first colorant in an amount ranging from about any of the foregoing amounts to about any other of the foregoing amounts.

In some embodiments, the second resin composition may include the second colorant in an amount of about 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the second resin composition can include the second colorant in an amount ranging from about any of the foregoing amounts to about any other of the foregoing amounts.

When the first and second resin compositions include the first and second colorants (first and second dyes and/or pigments), respectively, in an amount within these ranges, the resin compositions can provide transparency and opaqueness to each of the first and second molded products, respectively.

Each of the first and second resin composition may further include one or more additives such as but not limited to antibacterial agents, heat stabilizers, release agents, light stabilizers, inorganic material additives, surfactants, coupling agents, plasticizers, admixtures, stabilizers, lubricants, antistatic agents, tints, flame proofing agents, weather-resistance agents, ultraviolet (UV) absorbers, ultraviolet (UV) blocking agents, fillers, nucleating agents, adhesion aids, adhesives, and the like, and combinations thereof.

Exemplary release agents may include without limitation fluorine-containing polymers, silicone oils, metal salts of stearic acid, metal salts of montanic acid, montanic acid ester waxes, polyethylene waxes, and the like, and combinations thereof.

Exemplary the weather-resistance agents may include without limitation benzophenone-type weather-resistance agents, amine-type weather-resistance agents, and the like, and combinations thereof.

Exemplary ultraviolet (UV) blocking agents may include without limitation titanium oxide (TiO₂), carbon black, and the like, and combinations thereof.

Exemplary nucleating agents may include without limitation talc, clay, and the like, and combinations thereof.

Exemplary filler may include without limitation glass fiber, carbon fiber, silica, mica, alumina, clay, calcium carbonate, calcium sulfate, glass beads, and the like, and combinations thereof. When fillers are added, they can improve properties such as mechanical strength, heat resistance, and the like. The additive(s) can be used in an amount within an appropriate range as known in the art, so long as the additive(s) do not deteriorate properties of the first and second resin compositions.

The first and second resin compositions can be prepared using any well-known conventional methods. For example, the aforementioned components can be mixed, optionally with one or more additive(s). Then, the mixture can be melt-extruded in an extruder and prepared as pellets.

When the first and second molded products prepared as aforementioned are assembled into a molded product assembly, the assembly can have a metal texture. The metal texture is evaluated with the naked eye and can have gloss to some degree.

In other words, the molded product assembly can have a gloss ranging from about 70 to about 99 at about 60°, for example, from about 80 to about 99 at about 60°. In some embodiments, the molded product assembly may have a gloss of about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 at about 60°. Further, according to some embodiments of the present invention, the molded product assembly may have a gloss in a range from about any of the foregoing amounts to about any other of the foregoing amounts.

When a molded product assembly has a gloss within these ranges, it can be considered a very high quality product, that is to say, it can have a metal texture such as described herein (such as but not limited to brushed, patterned, pearlized, galvanized, rusted, distressed, stamped, shaved, impressed, that of a specific metal (such as the surface appearance of bronze, aluminum, copper, pewter, iron, etc.), sprayed, pearl, and the like).

As aforementioned, a molded product assembly prepared by assembling two molded products can have excellent metal texture due to a combination of color, gloss, transparency, corrosion pattern, and the like by adding a colorant (dye and/or pigment) to a plastic resin without adding a material such as a metal, aluminum flakes, sparkles, pearls, and the like, and accordingly can be used to manufacture plastic exterior products requiring high quality metal texture such as electronic parts, auto parts, and the like.

The following examples illustrate the present invention in more detail. However, they are exemplary embodiments and are not limiting.

### EXAMPLE

According to one embodiment, each component used for preparing a molded product assembly prepared by assembling first and second molded products is as follows.

(A) First Resin Composition for Preparing a First Molded Product

(A-1) First Resin

A polycarbonate resin (SC-1220, Cheil Industries Inc.) having a transparency of 85% is used as the first resin in Examples 1 to 4 and Comparative Examples 1 to 4.

A polycarbonate resin (SC-1220, Cheil Industries Inc.) having about a transparency of 95% is used as a first resin in Examples 5 and 6.

(A-2) First Dye/Pigment

A mixture of MACROLEX YELLOW G made by LANXESS Energizing Chemistry Co., which is a solvent-type dye, and SUMIPLAST YELLOW FL7G made by SUMIPLAST Ind. Ltd., which is a solvent-type dye, is used as a first dye/pigment in Examples 1 to 6.

A mixture of TiO₂ KRONOS 2232 made by KRONOS Inc., which is an inorganic pigment, MACROLEX YELLOW G made by LANXESS Energizing Chemistry Co., which is a solvent-type dye, and SUMIPLAST YELLOW FL7G made by SUMIPLAST Ind. Ltd., which is a solvent-type dye is used as a first dye/pigment in Comparative Examples 1 to 4.

(B) Second Resin Composition for Preparing a Second Molded Product

(B-1) Second Resin

A polycarbonate resin having a transparency of about 85% (SC-1220, Cheil Industries inc.) is used as a second resin in Examples 1 to 6 and Comparative Examples 1 to 4.

(B-2) Second Dye/Pigment

A mixture of TiO₂ KRONOS 2232 made by KRONOS Inc., which is an inorganic pigment, CERES BLUE 3R made by LANXESS Energizing Chemistry Co., which is a solvent-type dye, and HI BLACK 50L (carbon black) made by KCB, which is an inorganic pigment, is used as a second dye/pigment in Examples 1 and 2 and Comparative Examples 2 and 4.

A mixture of TiO₂ KRONOS 2232 made by KRONOS Inc., which is an inorganic pigment, CERES BLUE 3R made by LANXESS Energizing Chemistry Co., which is a solvent-type dye, PVPAST BLUE A4R made by CLARIANT Co., and HI BLACK 50L (carbon black) made by KCB is used as a second dye/pigment in Examples 3 to 6 and Comparative Examples 1 and 3.

### Examples 1 to 6 and Comparative Examples 1 to 4

The aforementioned components are extruded in an amount provided in the following Table 1 at a feed rate of about 60 kg/hr, a screw speed of about 250 rpm, a temperature of about 250° C., and under screw configuration of about 45φ regular and L/D=29 in a common twin-screw extruder. Then, each extruded product is prepared into pellets.

The pellets of Examples 1 to 6 and Comparative Examples 1 to 4 are dried at about 100° C. for more than 3 hours, and then injection-molded at a shaping temperature ranging from about 250 to about 270° C. at a molding temperature ranging from about 60 to about 80° C. using a 10 oz injection molding machine, respectively, to prepare specimens of the first and second molded products. The second molded product is prepared using a mold having a corrosion pattern for injecting each specimen. The first molded product appears yellow, while the second molded product appears blue.

The properties of the specimens are measured in accordance with the following methods. The results are provided in the following Table 1.

(1) Transparency: evaluated by measuring how much light from a D65

(CIE standard) light source passes through a 2.5 mm-thick molded product by using a hazemeter (NDH-2000, NIPPON DENSHOKU Industries). The measurement values are calculated by using the following Equation 1.

Transparency(HZ)=diffusion transmittance(DF)/entire transmittance (TT)×100

Total transmittance(TT)=diffusion transmittance(DF)+parallel transmittance(PT) [Equation 1]

(2) Gloss: measured at about 60° by using a gloss meter (CAT. NO 4520, BYK-GARDNER Inc.

(3) Corrosion pattern depth: measured by using a surface roughness-measuring device (SJ-301, Mitutoyo Co.).

Each molded product assembly is prepared by assembling the first and second molded products of Examples 1 to 6 and Comparative Examples 1 to 4. The gloss of the molded product assemblies is measured in the same method as described herein. The results are provided in the following Table 1.

In addition, each molded product assembly is examined with the naked eye for metal texture. The results are ranked as follows: ⊚ (excellent), Δ (medium), and X (poor) in FIGS. 4A to 4C.

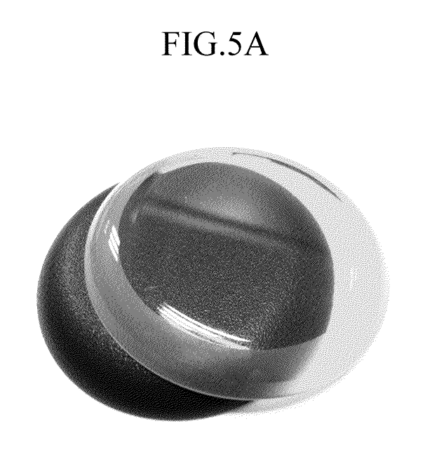

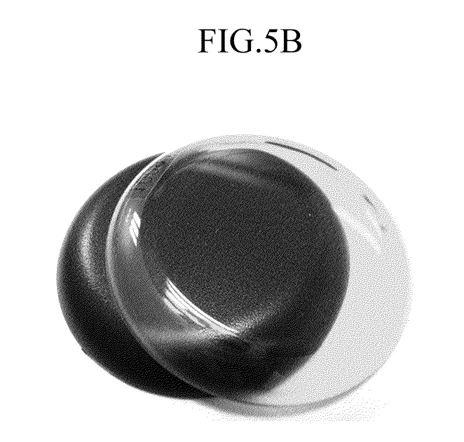

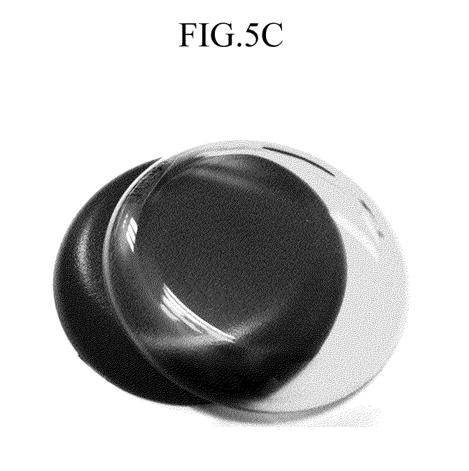

FIG. 5A is a photograph showing excellent metal texture (⊚) of the molded product assembly of Example 3. FIG. 5B is a photograph showing medium metal texture (Δ) of the molded product assembly of Example 2. FIG. 5C is a photograph showing poor metal texture (X) of the molded product assembly of Comparative Example 1. Referring to FIGS. 5A to 5C, each molded product assembly is identified according to the above ranking of metal texture.

TABLE 1

| | | Example | | | | | | Comparative Example | | | |
|---|---|---|---|---|---|---|---|---|---|---|---|
| | | 1 | 2 | 3 | 4 | 5 | 6 | 1 | 2 | 3 | 4 |
| First resin | First resin | 99 | 99 | 99.9 | 99.9 | 99.99 | 99.99 | 98.5 | 98.5 | 98 | 98 |
| composition | (wt %) | | | | | | | | | | |
| | First | 1 | 1 | 0.1 | 0.1 | 0.01 | 0.01 | 1.5 | 1.5 | 2 | 2 |
| | dye/pigment | | | | | | | | | | |
| | (wt %) | | | | | | | | | | |
| First molded | Transparency | 75 | 75 | 85 | 85 | 95 | 95 | 60 | 60 | 50 | 50 |
| product | (%) | | | | | | | | | | |
| | Gloss | 80 | 80 | 90 | 90 | 96 | 96 | 65 | 65 | 60 | 60 |
| Second | Second resin | 98.7 | 98.7 | 96.7 | 96.7 | 95.7 | 95.7 | 95.7 | 98.4 | 95.7 | 98.7 |
| resin | (wt %) | | | | | | | | | | |
| composition | Second | 1.3 | 1.3 | 3.3 | 3.3 | 4.3 | 4.3 | 4.3 | 1.6 | 4.3 | 1.3 |
| | dye/pigment | | | | | | | | | | |
| | (wt %) | | | | | | | | | | |
| | Corrosion | 15 | 45 | 15 | 45 | 15 | 45 | 15 | 15 | 45 | 45 |
| | pattern depth | | | | | | | | | | |
| | (μm) | | | | | | | | | | |
| Second | Transparency | 25 | 25 | 5 | 5 | 0.1 | 0.1 | 0.1 | 25 | 0.1 | 25 |
| molded | (%) | | | | | | | | | | |
| product | Gloss | 16 | 7 | 17 | 6 | 16 | 7 | 16 | 7 | 7 | 6 |
| A molded | Gloss | 80 | 80 | 90 | 90 | 96 | 96 | 65 | 65 | 60 | 60 |
| product | Naked eye | Δ | Δ | ⊚ | ⊚ | ⊚ | ⊚ | X | X | X | X |
| assembly | | | | | | | | | | | |

Tables 1 and 2 show that the molded product assemblies assembled including the first molded product having a transparency ranging from about 75 to about 99.9% and the second molded product having a transparency ranging from about 0.1 to about 50% according to Examples 1 to 6 have excellent metal texture as determined by observation with the naked eye and a gloss ranging from about 70 to about 99 at about 60°.

In contrast, the molded product assemblies assembled using the first molded product having a transparency outside the range of about 75 to about 99.9% according to Comparative Examples 1 to 4 have poor metal texture as determined by observation with the naked eye and a gloss outside of the range of about 70 to about 90 at about 60°. The first molded product includes a transparent resin, but includes the first dye/pigment in an amount greater than about 1 wt % and thus has a transparency of less than about 75%.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A molded product assembly comprising a first molded product having a transparency ranging from about 75 to about 99.9% and a second molded product having a transparency ranging from about 0.1 to about 50%, wherein said molded product assembly has a metal texture.

2. The molded product assembly of claim 1, wherein the first molded product has a gloss of about 70 or more at about 60°, and the second molded product has a gloss ranging from about 0.1 to about 40 at about 60°.

3. The molded product assembly of claim 1, wherein the second molded product has a corrosion pattern.

4. The molded product assembly of claim 3, wherein the corrosion pattern of the second molded product is in a range of about 0.001 to about 100 μm deep.

5. The molded product assembly of claim 1, wherein the first and second molded products have colors in a complementary color relationship.

6. The molded product assembly of claim 1, wherein the first and second molded products have colors in an opposite color relationship.

7. The molded product assembly of claim 1, wherein the first molded product comprises a first resin composition comprising a first resin having a transparency ranging from about 80 to about 99.9% and a first colorant, and the second molded product comprises a second resin composition comprising a second resin having transparency ranging from about 0 to about 99.9% and a second colorant.

8. The molded product assembly of claim 7, wherein each of the first and second resins independently comprises a synthetic resin, an environmentally-friendly resin, or a combination thereof.

9. The molded product assembly of claim 8, wherein each of the first and second resins independently comprises a rubber modified vinyl-based graft copolymer resin, a polyamide resin, a polycarbonate resin, a polyalkyl(meth)acrylate resin, a polyester resin, a polyolefin resin, a polylactic acid (PLA) resin, a polyhydroxy alkanoate (PHA) resin, a polybutylene succinate (PBS) resin, a starch resin, a plant-derived polyamide resin, a biosuccinic acid resin, or a combination thereof.

10. The molded product assembly of claim 7, wherein each of the first and second colorants independently comprises a dye, a pigment, or a combination thereof.

11. The molded product assembly of claim 10, wherein the dye comprises a solvent-type dye, a fluorescent whitening agent, a fluorescent dye, a mixed dye, or a combination thereof; and the pigment comprises an organic pigment comprising an anthraquinone-based pigment, a perylene-based pigment, a phthalocyanine pigment, an azo-based pigment, or a combination thereof; an inorganic pigment comprising carbon black, iron oxide black, a white pigment, a composite metal oxide, ultramarine blue, or a combination thereof; or a combination thereof.

12. The molded product assembly of claim 7, wherein the first resin composition comprises the first colorant in an amount ranging from about 0.01 to about 1 wt % based on the total weight of the first resin composition, and the second resin composition comprises the second colorant in an amount ranging from about 0.5 to about 50 wt % based on the total weight of the second resin composition.

13. The molded product assembly of claim 1, wherein the molded product assembly has a gloss ranging from about 70 to about 99 at about 60°.
